(19) United States
(12) Patent Application Publication
(10) Pub. No.: US 2021/0018052 A1
(43) Pub. Date: Jan. 21, 2021

(54) METHOD FOR CONTROLLING A CLUTCH ACTUATOR

(71) Applicant: Schaeffler Technologies AG & Co. KG, Herzogenaurach (DE)

(72) Inventors: Christian Eberle, Bühl (DE); Henrik Beier, Karlsruhe (DE)

(73) Assignee: Schaeffler Technologies AG & Co. KG, Herzogenaurach (DE)

(21) Appl. No.: 16/979,889

(22) PCT Filed: Mar. 13, 2019
(86) PCT No.: PCT/DE2019/100224

§ 371 Date: Sep. 11, 2020

(30) Foreign Application Priority Data
Mar. 16, 2018 (DE) 10 2018 106 174.9

(51) Int. Cl. F16D 48/02; F16D 48/06

(52) U.S. Cl. CPC F16D 48/02; F16D 2121/04; F16D 2048/0245; F16D 48/066

(57) ABSTRACT

A method controls a clutch actuator, comprising a clutch cylinder piston of a clutch cylinder, which clutch cylinder piston moves an actuation element of a friction clutch along an actuation path, and comprising a hydraulic pump, which actuates the clutch cylinder piston by means of a pressure medium pumped along a hydrostatic path and which is operated by means of an electric motor. In order to determine an actuation state of the friction clutch, the operating state along the actuation path is estimated by means of a pressure medium volumetric flow rate produced by the pump and by means of a leakage volumetric flow rate of the pump.

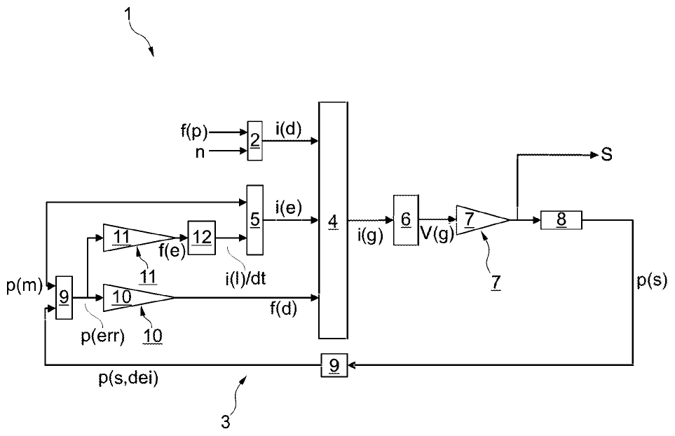

### CROSS-REFERENCE TO RELATED APPLICATIONS

This application is the U.S. National Phase of PCT Appln. No. PCT/DE2019/100224 filed Mar. 13, 2019, which claims priority to DE 102018106174.9 filed Mar. 16, 2018, the entire disclosures of which are incorporated by reference herein.

### TECHNICAL FIELD

The disclosure relates to a method for controlling a clutch actuator, having a clutch cylinder piston of a clutch cylinder, which clutch cylinder piston moves an actuation element of a friction clutch along an actuation path, and having a hydraulic pump, which actuates the clutch cylinder piston by means of a pressure medium pumped along a hydrostatic path and which is operated by means of an electric motor.

### BACKGROUND

Clutch actuators are used for the automated actuation of friction clutches, in particular in drive trains of motor vehicles, for example in order to disengage an internal combustion engine from a transmission or to frictionally engage them. For this purpose, clutch actuators are known in which the friction clutch is actuated along an actuation path by a clutch cylinder piston acting on an actuation element, for example a plate spring or lever elements, along the actuation element. The required system pressure to displace the clutch cylinder piston is provided by means of a hydrostatic clutch actuator, as is known from the publication DE 10 2010 047 800 A1. Here, an electric motor shifts a master cylinder piston, which acts on the clutch cylinder over a hydrostatic path, so that a path of the master cylinder piston or an angle of rotation of a rotor of the electric motor can be assigned to the actuation path of the friction clutch via the hydrostatic path when the transmission ratio between the rotor and master cylinder piston is known. A torque transmitted via the friction clutch can be assigned to the assigned actuation path via a clutch characteristic curve.

From the publication WO 95/26472 A1, a clutch actuator is known in which the clutch cylinder piston is acted upon by a hydraulic pump, wherein at least one hydraulic valve is provided between the pump and the clutch cylinder for controlling the volumetric flow rate of the pressure medium. The actuation path is detected using a separate sensor means.

From the publication WO 2015/120846 A1, a clutch actuator is known in which a clutch cylinder that actuates the friction clutch along an actuation path is acted upon directly, and without the interposition of valves with pressure medium from an electrically driven pump.

### SUMMARY

It is desirable to further develop a method for controlling a friction clutch by means of a clutch actuator having a clutch cylinder, which is supplied directly with pressure medium from an electrically driven pump. In particular, it is desirable to utilize an estimation of the operating state of the friction clutch without additional sensor elements for detecting the actuation path.

The proposed method is used to control a clutch actuator having a clutch cylinder, the clutch cylinder piston of which moves an actuation element of a friction clutch, for example a plate spring, at least one lever element, or a lever spring, along an actuation path. The clutch cylinder piston is moved by means of a hydraulic pump that delivers pressure medium directly and depending on its delivery volume. For this purpose, a hydrostatic path is formed between the pump and the clutch cylinder. The pump is driven by an electric motor. The pump can be designed, for example, as a gear pump, a rotary vane pump or the like. To determine the operating state of the friction clutch without a displacement sensor detecting the actuation path, the operating state along the actuation path is estimated by means of a pressure medium volume generated by the pump and a leakage volume of the pump. The operating state estimated in this way is derived from an assignment of the geometric relationships of the variable working volume of the clutch slave cylinder and an actuation path assigned to this variable working volume, wherein a torque transmissible via the friction clutch is determined depending on the actuation path and continuously adapted variables of the friction clutch, for example its coefficient of friction, and constant variables, for example, the friction surface of the friction clutch, on the basis of a clutch characteristic curve of the torque transmissible over the actuation path.

The pressure medium volume is determined on the basis of a variable dependent on the delivery rate of the pump. The pressure medium volume is preferably determined on the basis of an angle of rotation of the electric motor and a constant geometric pump factor. The angle of rotation of the electric motor is preferably determined on the basis of the detected angle of rotation signals of an electronically commutated electric motor. Here, the signals of a plurality of Hall sensors giving digital and/or analog signals can be evaluated so that, over a plurality of rotor revolutions of the electric motor, sufficiently high angular resolutions, and thus path differences in the actuation path of sufficient resolution, can be achieved, which in turn provide a sufficiently accurate determination of the torque transmissible by means of the friction clutch on the basis of the clutch characteristic curve.

In addition to the pressure medium volume, the leakage volume of the pump also contributes to the total power of the electric motor so that a correction quantity of the pressure medium volume is provided for the proportion of the leakage volume.

According to an advantageous embodiment of the method, a leakage rate forming the leakage volume over time is determined as a function of a pump pressure applied in the hydrostatic path. Since the leakage rate depends not only on the pump pressure but also on the viscosity of the pressure medium, the temperature of the pressure medium can also be taken into account. For this purpose, a temperature sensor in the hydrostatic path can be evaluated and/or a corresponding temperature model can be provided by evaluating a temperature sensor that is not present in the hydrostatic path.

The pump pressure is determined by means of a pressure sensor in the hydrostatic path. For example, the pressure sensor can be provided directly at the outlet of the pump, in a pressure line of the hydrostatic path, or in the clutch cylinder.

Due to the leakage rate possibly changing in short time intervals, it can be continuously adapted. Such an adaptation of the leakage rate can be provided as a function of an actually detected pump pressure and an expected pump pressure. For example, a pressure deviation of the detected pump pressure from the expected pump pressure can be determined as a function of a clutch characteristic curve of the actuating force over an estimated actuation path.

In addition, the pressure medium volume can be continuously adapted. For example, such adaptation processes can compensate for changes, for example temperature and/or operating time-related changes in the components of the friction clutch, such as setting processes, wear of the friction lining, readjustment processes of a self-adjusting friction clutch, changes in the clutch cylinder and/or the hydrostatic path.

A clutch actuator having a clutch cylinder and an electrically driven pump, acting on it via a hydrostatic path, and a control unit, controlling the clutch actuator, has software in which the proposed method is implemented is stored in the control device.

In other words, a software model estimates the actuation path of a friction clutch or a clutch cylinder (CSC) that is pressed closed or, preferably, pressed open, such as a clutch engagement or clutch disengagement cylinder, and thus estimates the actuation state of the friction clutch.

According to the following exemplary embodiment, the actuation path of the clutch cylinder is proportional to the hydraulic fluid volume it receives.

The hydraulic volume received herein is the difference between the pumped volume, namely the pressure medium volume, and the volume lost due to leakage, namely the leakage volume.

The pumped volume is proportional to the angle of rotation of the electric motor driving the pump. It must be multiplied by a constant factor, which can be determined from the pump geometry.

The volume lost due to leakage is proportional to the applied and measured pump pressure. The measured pump pressure must be multiplied by the adapted leakage rate to obtain the volume lost due to leakage.

The leakage rate is a factor that describes the leakage in the pump. It is not constant. In order to estimate the leakage rate as accurately as possible, its changes must be adapted and compensated as far as possible.

The leakage rate is adapted on the basis of the pressure deviation between a current pump pressure and an estimated pump pressure, which is determined from the estimated disengagement path and the clutch characteristic curve.

The basic idea is that if the disengagement path is correctly estimated, the real and estimated pressures are identical. If this is not the case, the pressure deviation results in a model correction.

The model correction, which takes place in the event of pressure deviations between the real and estimated pressures, contains both a term which changes the adapted leakage rate and a term which corrects the estimated hydraulic fluid volume of the CSC.

### BRIEF DESCRIPTION OF THE DRAWINGS

The invention is explained in more detail with reference to the exemplary embodiment in the single FIGURE. It shows a schematic diagram of a method for controlling a clutch actuator for estimating an operating state of the friction clutch.

### DETAILED DESCRIPTION

The FIGURE schematically shows the estimation of the actuation path s of a clutch cylinder piston of a clutch actuator, wherein the clutch cylinder piston is actuated by means of a pump operated by an electric motor and supplying pressure medium via a hydrostatic path. On the basis of the input variables of the rotational speed n of the pump, determined, for example, from a rotation angle detection of the rotor of the electric motor driving the pump, and the current measured pump pressure p(m) in the hydrostatic section, the actuation path s is determined and adapted using the model structure 3.

For this purpose, the rotational speed n and the essentially constant pump factor f(p), which reproduces the geometric relationships of the pump, are multiplied in block 2 to determine the pressure medium volumetric flow rate i(d), which generates the pressure medium volume for actuating a clutch cylinder, and an actuation path resulting therefrom.

To take the leakage of the pump into account, the leakage volumetric flow rate i(e) producing the leakage volume is determined. It is determined from the currently measured pump pressure p(m) and the adapted leakage rate i(l)/dt, determined in the model structure 3, which are combined multiplicatively in block 5.

An adapted correction factor f(d) for the pressure medium volumetric flow rate i(d) is also determined from the model structure 3. In block 4, the pressure medium volumetric flow rate i(d), the leakage rate i(e), and the pressure medium correction factor f(d) are respectively combined for a predetermined time interval, for example one or more interrupts. The total volumetric flow rate i(g) is integrated in the integrator 6 over a predetermined time of predetermined interrupts and optionally filtered and averaged. In the calculation term 7, the total volume V(g), obtained in the integrator 6 from the leakage volume and the pressure medium volume, is converted into the actuation path s of the clutch cylinder piston or the actuation element of the friction clutch, using the geometric properties of the clutch cylinder.

The model structure 3 uses the currently set actuation path s and, in block 8, converts it into an estimated pump pressure p(s), which is delayed by an interrupt in block 9, on the basis of a model which is designed to match the real clutch actuator. In block 9, the delayed estimated pump pressure p(s,del) is subtracted from the currently measured pump pressure p(m) and a pump pressure error p(err) is determined. Based on this pump pressure error p(err), the leakage correction factor f(e) and the pressure medium correction factor f(d) are determined in the calculation terms 10, 11. The leakage correction factor f(e) is then used to calculate the adapted leakage rate i(l)/dt in block 12 and converted into the leakage volumetric flow rate i(e), using the measured pump pressure p(m). In addition to the pressure medium volumetric flow rate i(d) and the leakage volumetric flow rate i(e), the pressure medium correction factor f(d), which is continuously corrected during one or more interrupts, is supplied to block 4 so that both the pressure medium volumetric flow rate i(d) and the leakage volumetric flow rate i(e) as well as their volumes are continuously adapted using the model structure 3.

### LIST OF REFERENCE SYMBOLS

1 Schematic diagram
2 Block
3 Model structure
4 Block
5 Block
6 Integrator
7 Calculation term
8 Block
9 Block
10 Calculation term
11 Calculation term
12 Block
f(d) Pressure medium correction factor
f(e) Leakage correction factor
f(p) Pump factor
i(d) Pressure medium volumetric flow rate
i(g) Total volumetric flow rate
i(e) Leakage volumetric flow rate
i(l)/dt Leakage rate
n Rotational speed
p(err) Pump pressure error
p(m) Pump pressure
p(s) Pump pressure
p(s,del) Pump pressure, delayed
s Actuation path
V(g) Total volume

1. A method for controlling a clutch actuator having a clutch cylinder piston of a clutch cylinder, which clutch cylinder piston actuation element moves an actuation element of a friction clutch along an actuation path, and having a hydraulic pump, which actuates the clutch cylinder piston by a pressure medium pumped along a hydrostatic path and which is operated by an electric motor, wherein an operating state of the friction clutch along the actuation path is estimated using pressure medium volumetric flow rate produced by the pump and a leakage volumetric flow rate of the pump.

2. The method according to claim 1, wherein the pressure medium volumetric flow rate is determined using an angle of rotation of the electric motor and a constant geometric pump factor.

3. The method according to claim 1, wherein a leakage rate forming the leakage volumetric flow rate over time is determined as a function of a pump pressure applied in the hydrostatic path.

4. The method according to claim 3, wherein the pump pressure is determined by a pressure sensor.

5. The method according to claim 3, wherein the leakage rate is continuously adapted.

6. The method according to claim 5, wherein an adaptation of the leakage rate is provided as a function of an actually detected pump pressure and an estimated pump pressure.

7. The method according to claim 6, wherein a pressure deviation of the detected pump pressure from the estimated pump pressure is determined as a function of a clutch characteristic curve of the actuating force over an estimated actuation path.

8. The method according to claim 1, wherein the pressure medium volumetric flow rate is continuously adapted.

9. The method according to claim 1, wherein the pressure medium volumetric flow rate and the leakage volumetric flow rate area adapted in a common model structure.

10. A clutch actuator having a clutch cylinder and an electrically driven pump, acting on it via a hydrostatic path, and having a control device controlling the clutch actuator with software implementing the method of claim 1 and stored in the control device.

11. The method according to claim 2, wherein the pressure medium volumetric flow rate is continuously adapted.

12. The method according to claim 11, wherein a leakage rate forming the leakage volumetric flow rate over time is determined as a function of a pump pressure applied in the hydrostatic path.

13. The method according to claim 12, wherein the pump pressure is determined by a pressure sensor.

14. The method according to claim 12, wherein the leakage rate is continuously adapted.

15. The method according to claim 14, wherein an adaptation of the leakage rate is provided as a function of an actually detected pump pressure and an estimated pump pressure.

16. The method according to claim 15, wherein a pressure deviation of the detected pump pressure from the estimated pump pressure is determined as a function of a clutch characteristic curve of the actuating force over an estimated actuation path.
